(19) United States
(12) Patent Application Publication
(10) Pub. No.: US 2013/0114684 A1
(43) Pub. Date: May 9, 2013

(54) ELECTRONIC DEVICES FOR SELECTIVE RUN-LEVEL CODING AND DECODING

(71) Applicants: Seung-Hwan Kim, Vancouver, WA (US); Christopher A. Segall, Camas, WA (US)

(72) Inventors: Seung-Hwan Kim, Vancouver, WA (US); Christopher A. Segall, Camas, WA (US)

(73) Assignee: Sharp Laboratories of America, Inc., Camas, WA (US)

(21) Appl. No.: 13/290,998

(22) Filed: Nov. 7, 2011

(51) Int. Cl. H04N 7/30

(52) U.S. Cl. 375/240.03; 375/E07.126

(57) ABSTRACT

An electronic device configured for selective run-level coding (SRLC) is described. The electronic device includes a processor and instructions stored in memory that is in electronic communication with the processor. The electronic device obtains a block of transformed and quantized coefficients (TQCs). The electronic device also determines whether to skip run-level coding. The electronic device further level codes any remaining TQCs if it is determined to skip run-level coding. The electronic device additionally run-level codes one or more TQCs if it is determined not to skip run-level coding and level codes any remaining TQCs if it is determined not to skip run-level coding.

### TECHNICAL FIELD

The present disclosure relates generally to electronic devices. More specifically, the present disclosure relates to electronic devices for selective run-level coding and decoding.

### BACKGROUND

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be produced or consumed at almost any location where a consumer may be. Furthermore, some electronic devices may provide download or streaming of digital media content for the use and enjoyment of a consumer.

The increasing popularity of digital media has presented several problems. For example, efficiently representing high-quality digital media for storage, transmittal and playback presents several challenges. As can be observed from this discussion, systems and methods that represent digital media more efficiently may be beneficial.

### BRIEF DESCRIPTION OF THE DRAWINGS

FIG. 1 is a block diagram illustrating one configuration of an electronic device in which systems and methods for selective run-level coding (SRLC) may be implemented;

FIG. 2 is a flow diagram illustrating one configuration of a method for selective run-level coding (SRLC) on an electronic device;

FIG. 3 is a flow diagram illustrating one configuration of a method for determining whether to skip run-level coding;

FIG. 4 is a flow diagram illustrating another configuration of a method for selective run-level coding (SRLC) on an electronic device;

FIG. 5 is a block diagram illustrating one configuration of an electronic device in which systems and methods for selected run-level decoding may be implemented;

FIG. 6 is a flow diagram illustrating one configuration of a method for selective run-level decoding on an electronic device;

FIG. 7 is a flow diagram illustrating another configuration of a method for selective run-level decoding on an electronic device;

FIG. 8 is a flow diagram illustrating examples of a method for determining whether to skip run-level decoding;

FIG. 9 is a block diagram illustrating one example of a coder and a decoder; and

FIG. 10 illustrates various components that may be utilized in an electronic device.

### DETAILED DESCRIPTION

An electronic device configured for selective run-level coding (SRLC) is described. The electronic device includes a processor and instructions stored in memory that is in electronic communication with the processor. The electronic device obtains a block of transformed and quantized coefficients (TQCs). The electronic device also determines whether to skip run-level coding. The electronic device further level codes any remaining TQCs if it is determined to skip run-level coding. The electronic device additionally run-level codes one or more TQCs if it is determined not to skip run-level coding. The electronic device also level codes any remaining TQCs if it is determined not to skip run-level coding. The electronic device may also insert a classification indicator into a bitstream.

Determining whether to skip run-level coding may be based on at least one of a quantization parameter (QP), resolution information, a block type, a block size and a trailing one (TR1). The block may be high resolution if the block is from a picture with a width that is greater than or equal to 1280 pixels.

Determining whether to skip run-level coding may include determining a bit rate category of the block based on a quantization parameter (QP). Determining whether to skip run-level coding may also include determining to not skip run-level coding if a low bit rate category is determined.

If a very high bit rate category is determined, then the electronic device may determine whether the block is high resolution. The electronic device may also determine whether a second condition is met if the block is high resolution. The electronic device may further determine to skip run-level coding if the second condition is met. The electronic device may additionally determine to not skip run-level coding if the second condition is not met. The electronic device may also determine whether a first condition is met if the block is not high resolution. The electronic device may further determine to skip run-level coding if the first condition is met. The electronic device may additionally determine to not skip run-level coding if the first condition is not met.

If a high bit rate category is determined, then the electronic device may determine whether the block is high resolution. The electronic device may also determine whether a third condition is met if the block is high resolution. The electronic device may further determine to skip run-level coding if the third condition is met. The electronic device may additionally determine to not skip run-level coding if the third condition is not met. The electronic device may also determine whether a first condition is met if the block is not high resolution. The electronic device may further determine to skip run-level coding if the first condition is met. The electronic device may additionally determine to not skip run-level coding if the first condition is not met.

If a mid bit rate category is determined, then the electronic device may determine whether a fourth condition is met. The electronic device may also determine to skip run-level coding if the fourth condition is met. The electronic device may further determine to not skip run-level coding if the fourth condition is not met.

A very high bit rate category may be determined if the QP is less than a first threshold, a high bit rate category may be determined if the first threshold is less than or equal to the QP and if the QP is less than a second threshold. Furthermore, a mid bit rate category may be determined if the second threshold is less than or equal to the QP and if the QP is less than a third threshold and the low bit rate category may be determined if the QP is greater than or equal to the third threshold.

An electronic device configured for selective run-level decoding is also described. The electronic device includes a processor and instructions stored in memory that is in electronic communication with the processor. The electronic device obtains a set of coded transformed and quantized coefficients (TQCs). The electronic device also determines whether to skip run-level decoding. The electronic device further level decodes any remaining coded TQCs in the set of coded TQCs if it is determined to skip run-level decoding. The electronic device additionally run-level decodes one or more TQCs in the set of coded TQCs if it is determined not to skip run-level decoding. The electronic device also level decodes any remaining TQCs if it is determined not to skip run-level decoding.

Determining whether to skip run-level decoding may be based on at least one of a quantization parameter (QP), resolution information, a block type, a block size, a trailing one (TR1) and a classification indicator. Determining whether to skip run-level decoding may be based on a classification indicator obtained from a bitstream.

Determining whether to skip run-level decoding may include determining a bit rate category of the set. Determining whether to skip run-level decoding may also include determining to not skip run-level decoding if a low bit rate category is determined.

If a very high bit rate category is determined, then the electronic device may determine whether the set is high resolution. The electronic device may also determine whether a second condition is met if the set is high resolution. The electronic device may further determine to skip run-level decoding if the second condition is met. The electronic device may additionally determine to not skip run-level decoding if the second condition is not met. The electronic device may also determine whether a first condition is met if the set is not high resolution. The electronic device may further determine to skip run-level decoding if the first condition is met. The electronic device may additionally determine to not skip run-level decoding if the first condition is not met.

If a high bit rate category is determined, then the electronic device may determine whether the set is high resolution. The electronic device may also determine whether a third condition is met if the set is high resolution. The electronic device may further determine to skip run-level decoding if the third condition is met. The electronic device may additionally determine to not skip run-level decoding if the third condition is not met. The electronic device may also determine whether a first condition is met if the set is not high resolution. The electronic device may further determine to skip run-level decoding if the first condition is met. The electronic device may additionally determine to not skip run-level decoding if the first condition is not met.

If a mid bit rate category is determined, then the electronic device may determine whether a fourth condition is met. The electronic device may also determine to skip run-level decoding if the fourth condition is met. The electronic device may further determine to not skip run-level decoding if the fourth condition is not met.

A method for selective run-level coding (SRLC) on an electronic device is also described. The method includes obtaining a block of transformed and quantized coefficients (TQCs). The method also includes determining whether to skip run-level coding. The method further includes level coding any remaining TQCs if it is determined to skip run-level coding. The method additionally includes run-level coding one or more TQCs if it is determined not to skip run-level coding. The method also includes level coding any remaining TQCs if it is determined not to skip run-level coding.

A method configured for selective run-level decoding on an electronic device is also described. The method includes obtaining a set of coded transformed and quantized coefficients (TQCs). The method also includes determining whether to skip run-level decoding. The method further includes level decoding any remaining coded TQCs in the set of coded TQCs if it is determined to skip run-level decoding. The method additionally includes run-level decoding one or more TQCs in the set of coded TQCs if it is determined not to skip run-level decoding. The method also includes level decoding any remaining TQCs if it is determined not to skip run-level decoding.

The Joint Collaborative Team on Video Coding (JCT-VC) of the International Telecommunication Union Telecommunication Standardization Sector (ITU-T) Study Group 16 (SG16) Working Party 3 (WP3) and International Organization for Standardization/International Electrotechnical Commission (ISO/IEC) Joint Technical Committee 1/Subcommittee 29/Working Group 11 (JTC1/SC29/WG11) has launched a standardization effort for a video coding standard called the High Efficiency Video Coding standard (HEVC). Similar to some prior video coding standards, HEVC is block-based coding.

In HEVC, two entropy coding techniques (e.g., Context-Adaptive Variable Length Coding (CAVLC) and Context-Adaptive Binary Arithmetic Coding CABAC)) are used to compress Transformed and Quantized Coefficients (TQCs) without loss. TQCs may be from different block sizes according to transform sizes (e.g., 4×4, 8×8, 16×16, 32×32).

Two-dimensional (2D) TQCs may be converted into a one-dimensional (1D) array before entropy coding. In one example, 2D arrayed TQCs in a 4×4 block may be arranged as illustrated in Table (1).

TABLE (1)

| | | | |
|---|---|---|---|
| 4 | 0 | 1 | 0 |
| 3 | 2 | −1 | . . . |
| −3 | 0 | . . . | . . . |
| 0 | . . . | . . . | . . . |

When converting the 2D TQCs into a 1D array, the block may be scanned in a diagonal zig-zag fashion. Continuing with the example, the 2D arrayed TQCs illustrated in Table (1) may be converted into 1D arrayed TQCs [4, 0, 3, −3, 2, 1, 0, −1, 0, . . . ] by scanning the first row and first column, first row and second column, second row and first column, third row and first column, second row and second column, first row and third column, first row and fourth column, second row and third column, third row and second column, fourth row and first column and so on.

The CAVLC coding procedure in HEVC may proceed as follows. The TQCs in the 1D array may be ordered according to scanning position. The scanning position of the last significant coefficient and the last coefficient level may be determined. The last significant coefficient may be coded. It should be noted that coefficients are coded in reverse scanning order. Run-level coding may be performed, which is activated directly after the last coefficient coding. Then, level coding may be performed. The term significant coefficient refers to a coefficient that has a coefficient level value that is greater than zero. A coefficient level value refers to a unique indicator of the magnitude (or absolute value) of a Transformed and Quantized Coefficient (TQC) value.

This procedure may be illustrated in Table (2) as a continuation of the example above (with the 1D arrayed TQCs [4, 0, 3, −3, 2, 1, 0, −1, 0, . . . ]).

TABLE (2)

| | Scanning Position | | | | | | | | |
|---|---|---|---|---|---|---|---|---|---|
| | 0 | 1 | 2 | 3 | 4 | 5 | 6 | 7 | . . . |
| | Coefficient Level | | | | | | | | |
| | 4 | 0 | 3 | −3 | 2 | 1 | 0 | −1 | . . . |
| Last Position | | | | | | | | 7 | |
| Last Coefficient Level | | | | | | | | −1 | |
| Run-Level Coding | | | | | 2 | 1 | 0 | | |
| Level Coding | 4 | 0 | 3 | −3 | | | | | |

In Table (2), for example, the coefficient level −1 at scanning position 7 may be the last non-zero coefficient. Thus, the last position is scanning position 7 and the last coefficient level is −1. Run-level coding may be performed for coefficients 0, 1 and 2 at scanning positions 6, 5 and 4 (where coefficients are coded in reverse scanning order). Then, level coding may be performed for the coefficient levels −3, 3, 0 and 4.

More detail on run-level coding for CAVLC is given hereafter. Consecutive zeros (“run”) and “lev” information may be coded together. “lev” indicates whether or not the level, or coefficient level, of the following significant coefficient is equal to one (e.g., lev is set to zero if the level is equal to 1). For example, 0, 0, 0, 1 may be coded as (3, 0) and 0, 0, 0, 2 may be coded as (3, 1). A predefined Variable Length Code (VLC) table is used to code the symbol (run, lev). The level of the significant coefficient is coded based on the “lev” information. In a first case where lev=0, only one bit of a sign flag may be transmitted, where positive (e.g., “+”) is represented as 0 and negative (e.g., “−”) is represented as 1. In a second case where lev=1, the level and sign (e.g., “+” or “−”) values are coded together. For example, 2*(level−2)+sign is coded using VLC table-0 in Table (3).

Continuing with the example above, coefficients 0, 1, 2 may be run-level coded as (1, 0), (0), (0, 1), (0). In this example, (1, 0) and (0) represent (run, lev) and (sign) of 0 and 1, and (0, 1) and (0) represent (run, lev) and (2*(level−2)+sign) of 2.

More detail on a level coding start condition and level coding is given hereafter. Level coding may begin (e.g., be activated) directly after the run-level coding mode is terminated. The run-level coding is terminated in the following conditions: if level >1 and block size=4, if level >1 and scanning position <Threshold (where Threshold depends on block type) or if level >2. In level coding, all of the remaining coefficients are coded including zeros and significant symbols. VLC tables are monotonically increased when a previous level is larger than a given threshold value. Five VLC tables are available in the level coding. Continuing the above example, coefficients −3, 3, 0, 4 (in reverse order) may be coded using level coding.

Table (3) illustrates various VLC tables that are used in CAVLC. In particular, five VLC tables are mainly used.

TABLE (3)

| | VLC- | VLC- | VLC- | VLC- | VLC- | |
|---|---|---|---|---|---|---|
| | Table0 | Table1 | Table2 | Table3 | Table4 | |
| Code | Input | Input | Input | Input | Input | . . . |
| Length | Value | Value | Value | Value | Value | . . . |
| 1 | 0 | — | — | — | — | . . . |
| 2 | 1 | 0, 1 | — | — | 0, 1 | . . . |
| 3 | 2 | 2, 3 | 0~3 | — | 2, 3 | . . . |
| 4 | 3 | 4, 5 | 4~7 | 0~7 | 4, 5 | . . . |
| 5 | 4 | 6, 7 | 8~11 | 8~15 | 6, 7 | . . . |
| 6 | 5 | 8, 9 | 12~15 | 16~23 | 8, 9 | . . . |
| 7 | 6 | 10, 11 | 16~19 | 24~31 | 10, 11 | . . . |
| 8 | — | 12, 13 | 20~23 | . . . | 12, 13 | . . . |
| 9 | 7, 8 | — | 24~27 | | . . . | . . . |
| 10 | — | 14~17 | 28~31 | | | |
| 11 | 9~12 | — | . . . | | | |
| 12 | — | 18~25 | | | | |

Current run-level coding in CAVLC is efficient to code the level value of ‘1’ because only the sign flag is needed to be transmitted. However, one problem of the current run-level coding process is that in a high bit-rate coding condition (with a small quantization parameter (QP) value, for example), the probability distribution of the level value of 1 is significantly decreased. Thus, the current run-level coding procedure produces significant additional coding bits (the number of additional coding bits depends on the corresponding VLC tables that are determined by current coding conditions such as block size and scanning position) to code “lev” information, which is equal to 1. For example, coefficients 0, 1, 2 may be run-level coded as (1, 0), (0), (0, 1), (0). In this example, (1, 0) and (0) represent (run, lev) and (sign) of 0 and 1, and (0, 1) and (0) represent (run, lev) and (2*(level−2)+sign) of 2.

For another example, also assume that a current max_run=12. Also, assume that VLC-Table2 is used from Table (3) above. The symbol (run, lev) may be coded as follows. (run, lev) is mapped into ‘input value’ (from Table (3)). If lev=0, then the input value=run. In this example for (1, 0), the input value is 1. If lev=1, then the input value=max_run+run. The value of max_run is equal to the current scanning position. Thus, in this example for (0, 1), the input value is 13.

The input value is then coded based on the given VLC table (e.g., VLC-Table2). Accordingly, the code length is 3 for (1, 0) and the code length is 6 for (0, 1) in this example. As described, it requires many additional bits to code the case of lev=1. Statistically, there are many large coefficients that are larger than one in high bit-rate coding. In accordance with the systems and methods disclosed herein, the current CAVLC coding structure may be modified to deal with this issue.

The systems and methods disclosed herein may introduce a more generalized coding structure for CAVLC in HEVC. Furthermore, the systems and methods herein may improve the coding performance of CAVLC in high bit-rate coding and reduce the computational complexity consumed in run-level coding (which is the most complex coding part in CAVLC).

The systems and methods disclosed herein may use a more advanced CAVLC coding structure for high bit-rate coding by selectively employing the run-level coding mode. The systems and methods disclosed herein may apply a selective technique to determine whether to skip run-level coding. For example, the systems and methods disclosed herein may use a quantization parameter, resolution information, a block type, a block size and a trailing one (TR1) to determine a run-level skip mode (e.g., a run-level flag).

The systems and methods disclosed herein may determine (e.g., select) whether to employ or skip run-level coding in order to improve high bit-rate coding performance. Additionally, the systems and methods herein may be applied to the current CAVLC structure for low bit-rate coding.

For example, whether to employ or skip run-level coding may be based on a run-level flag. In order to control the run-level flag, a quantization parameter (QP) and a resolution of input video may be used to classify a block into one of multiple (e.g., five) categories. Once the category of a block is determined (e.g., classified), the run-level flag may be (efficiently) determined based on block type, block size and TR1. The trailing one (TR1) represents whether or not the level of the last significant coefficient is equal to ‘1.’ This approach may be denoted as selective run-level coding (SRLC). SRLC may be beneficial by reducing the number of tables required to decode a block of coefficients. This benefit results because the tables for run-level coding are not used when run-level coding is skipped.

It should be noted that TR1 and “lev” may be used to represent whether the level of a given coefficient is equal to one, though TR1 and “lev” represent this differently. For example, if the level of the given coefficient is equal to one, then “lev” is set to 0, but TR1 is set to 1.

In accordance with the systems and methods disclosed herein, selective run-level coding (SRLC) may be controlled based on a run-level flag. In some configurations, the run-level flag may be determined as follows. A block may first be classified into one of a number of categories (e.g., four categories) based on a quantization parameter (QP) and one or more thresholds. In one configuration, three thresholds may be used, denoted as a first threshold (TH1), a second threshold (TH2) and a third threshold (TH3). For example, if the QP<TH1 (indicating a very high bit rate, for instance), the block may be classified into a very high bit rate category. For instance, if TH1=16 and QP<16, the block may be classified in the very high bit rate category. If TH1≦QP<TH2 (indicating a high bit rate, for instance), the block may be classified in a high bit rate category. For instance, if TH2=20 and 16≦QP<20, the block may be classified in the high bit rate category. If TH2≦QP<TH3 (indicating a mid bit rate, for instance), the block may be classified in a mid bit rate category. For instance, if TH3=26 and 20≦QP<26, the block may be classified in the mid bit rate category. If QP is ≧TH3 (indicating a low bit rate, for instance), the block may be classified in a low bit rate category. For instance, if TH3=26 and QP≧26, the block may be classified in the low bit rate category. In the low bit rate category, the run-level flag may be 1 (indicating not skipping run-level coding, for example).

In some configurations, the bit rate category may be coded for transmission in a slice header for a corresponding block. For example, two bits may be used to indicate which of the categories (e.g., very high bit rate, high bit rate, mid bit rate or low bit rate) the block is classified into. These bits (in a classification indicator, for example) may be added to the slice header by a coder and transmitted to a decoder in a bitstream.

For the very high bit rate category and high bit rate category, a block may be further classified based on a resolution. For example, a block in the very high or high bit rate categories may be classified as high resolution or not. In some configurations, high resolution may be determined if an image dimension is greater than or equal to a resolution threshold. For example, high resolution may be determined if an image width is greater than or equal to 1280 pixels.

In some configurations, images with the following resolutions (in width×height in pixels) may be classified as high resolution: 4K (2560×1600), 1080P (1920×1080) and 720P (1280×720). Additionally or alternatively, images with the following resolutions (in width×height in pixels) may be classified as low resolution: WVGA (832×480) and WQVGA (416×240). In some configurations, the resolution category may be coded for transmission in the slice header of a corresponding block. For example, one bit may be used to indicate whether the block is high resolution or low resolution. This bit (e.g., a resolution flag) may be added to the slice header (in addition to or alternatively from bit rate information in a classification indicator, for example) by a coder and transmitted to a decoder in a bitstream. Alternatively, a decoder may classify a block or set of TQCs based on a resolution that is derived from the bitstream (and not from an explicit flag, for example).

As described above, classification may be based on one or more bits (e.g., flags) in a bitstream. For example, a decoder may select between multiple classification procedures depending on a bitstream signal.

For the block, the run-level flag may then be determined based on block size or block type and TR1. In some configurations, whether or not the block size or block type and TR1 meet certain criteria may be expressed as conditions. For example, a first condition (C1) may be based on a TR1 value and whether the block size is equal to one or more block size values (e.g., 4 or 8). For instance, C1 may be met if ((block size==4 && TR1==0) 11 block size==8), where “&&” denotes a logical “and,” “∥” denotes a logical “or” and “==” denotes “equal to.” Additionally, a second condition (C2) may be based on a TR1 value and whether the block type is equal to a block type value (e.g., 4). For instance, C2 may be met if (block type==4 && TR1==0). Additionally, a third condition (C3) may be based on a TR1 value and whether the block size is less than a block size value (e.g., 16). For instance, C3 may be met if (block size <16 && TR1==0). Additionally, a fourth condition (C4) may be based on a TR1 value and whether the block size is equal to a block size value (e.g., 4). For instance, C4 may be met if (block size==4 && TR1==0).

It should be noted that TR1 is set to ‘1’ if the level of the last non-zero coefficient is equal to ‘1’ and may be set to ‘0’ otherwise. It should also be noted that both TR1 information and lev information are used to represent whether or not the absolute level of the last significant coefficient is equal to one. However, they have different values for the same case. For example, if the last coefficient value is equal to 1, TR1 and lev are differently set to ‘1’ and ‘0,’ respectively.

The performance of one configuration of the systems and methods disclosed herein was tested. A first test evaluated rate distortion (RD) performance of SRLC versus a test model of HEVC known as HM4.0. Software based on latest HEVC test model HM4.0 (as of August 2011) was employed. High bit rate coding conditions QP=10, 12, 15 and 17 were utilized. Test results show that the SRLC provides about a 0.5% rate decrease in high bit rate coding conditions. More improvement may be possible by taking more block information into account.

Table (4) illustrates test results from the first test. It should be noted that “Low Complexity” mode is abbreviated as “LC” in Tables (4) and (5) for convenience. In HEVC, there are two entropy coders (CAVLC and CABAC). CAVLC is activated in a Low Complexity (LC) mode and CABAC is activated in a High Efficiency (HE) mode. In testing, the LC test condition is selected for CAVLC. YUV is a color space often used in video coding standards. In Tables (4) and (5), Y stands for the luminance component (the brightness) and U and V represent the chrominance (color) component. In Tables (4)-(5), Classes A-E represent predefined sets of test video sequences according to their resolutions. For example, resolutions may be as follows: Class A: 4K (2560×1600), Class B: 1080P (1920×1080), Class C: WVGA (832×480), Class D: WQVGA (416×240) and Class E: 720P (1280×720).

TABLE (4)

| | Low Delay (B) LC | | | Random Access LC | | |
|---|---|---|---|---|---|---|
| | Y | U | V | Y | U | V |
| Class A | −0.4% | −0.2% | −0.2% | −0.4% | −0.2% | −0.2% |
| Class B | −0.4% | −0.3% | −0.2% | −0.4% | −0.3% | −0.4% |
| Class C | −1.0% | −0.7% | −0.8% | −0.8% | −0.4% | −0.4% |
| Class D | −1.2% | −0.8% | −0.7% | −1.0% | −0.3% | −0.5% |
| Class E | −0.3% | −0.2% | −0.2% | −0.5% | −0.3% | −0.4% |
| Overall | −0.7% | −0.4% | −0.4% | −0.6% | −0.3% | −0.4% |

The performance of one configuration of the systems and methods disclosed herein was tested. A second test evaluated rate distortion (RD) performance of SRLC versus a test model of HEVC known as HM4.0. Software based on latest HEVC test model HM4.0 (as of August 2011) was employed. Mid-to-high bit rate coding conditions QP=12, 17, 22 and 27 were utilized. Test results show that the SRLC provides about a 0.25% rate decrease in mid-to-high bit rate coding conditions. More improvement may be possible by taking more block information into account. Table (5) illustrates test results from the second test.

TABLE (5)

| | Low Delay (B) LC | | | Random Access LC | | |
|---|---|---|---|---|---|---|
| | Y | U | V | Y | U | V |
| Class A | −0.2% | −0.1% | −0.1% | −0.2% | −0.3% | −0.3% |
| Class B | −0.2% | −0.2% | −0.0% | −0.1% | −0.2% | −0.2% |
| Class C | −0.5% | −0.2% | −0.4% | −0.1% | −0.2% | −0.2% |
| Class D | −0.4% | −0.2% | −0.3% | −0.4% | −0.4% | −0.4% |
| Class E | −0.1% | −0.1% | −0.1% | −0.3% | −0.3% | −0.5% |
| Overall | −0.3% | −0.2% | −0.2% | −0.2% | −0.3% | −0.3% |

As described above, the systems and methods disclosed herein may use a more advanced CAVLC coding structure for high bit-rate coding by selectively employing or skipping the run-level coding mode. This may provide a benefit of improving the CAVLC coding performance in high bit-rate coding conditions. Another benefit may be reducing computational complexity when the run-level mode is selected, since the run-level mode currently requires increased computational complexity in CAVLC.

The systems and methods disclosed herein may apply a selection procedure or technique to determine whether to skip run-level coding. This may provide a benefit of achieving a more generalized CAVLC coding structure that may be efficient for all bit rates and also reduce the computational complexity if necessary.

The systems and methods disclosed herein may use a quantization parameter, resolution information, a block type, a block size and a trailing one (TR1) to classify blocks for run-level skipping. This may provide a benefit of increasing the accuracy of determining a run-level skip (flag) and improve the coding performance.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

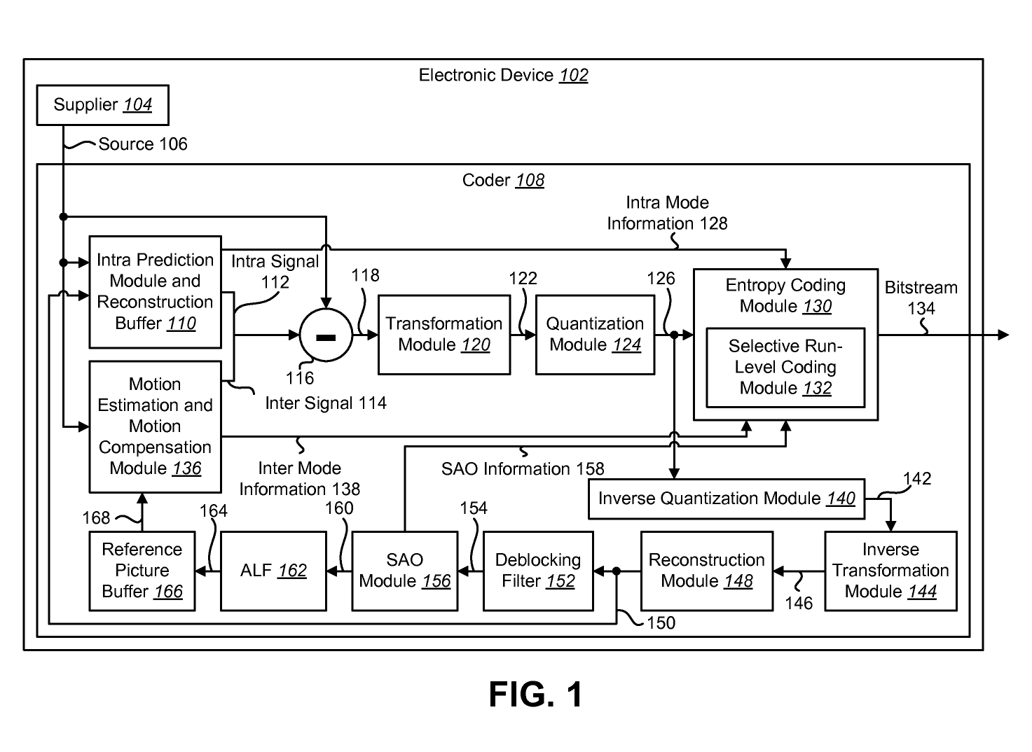

FIG. 1 is a block diagram illustrating one configuration of an electronic device 102 in which systems and methods for selective run-level coding (SRLC) may be implemented. It should be noted that one or more of the elements illustrated as included within the electronic device 102 may be implemented in hardware, software or a combination of both. For example, the electronic device 102 includes a coder 108, which may be implemented in hardware, software or a combination of both. For instance, the coder 108 may be implemented as a circuit, integrated circuit, application-specific integrated circuit (ASIC), processor in electronic communication with memory with executable instructions, firmware, field-programmable gate array (FPGA), etc., or a combination thereof. In some configurations, the coder 108 may be a high efficiency video coding (HEVC) coder.

The electronic device 102 may include a supplier 104. The supplier 104 may provide picture or image data (e.g., video) as a source 106 to the coder 108. Examples of the supplier 104 include image sensors, memory, communication interfaces, network interfaces, wireless receivers, ports, etc.

The source 106 may be provided to an intra-frame prediction module and reconstruction buffer 110. The source 106 may also be provided to a motion estimation and motion compensation module 136 and to a subtraction module 116.

The intra-frame prediction module and reconstruction buffer 110 may generate intra mode information 128 and an intra signal 112 based on the source 106 and reconstructed data 150. The motion estimation and motion compensation module 136 may generate inter mode information 138 and an inter signal 114 based on the source 106 and a reference picture buffer 166 signal 168. The reference picture buffer 166 signal 168 may include data from one or more reference pictures stored in the reference picture buffer 166.

The coder 108 may select between the intra signal 112 and the inter signal 114 in accordance with a mode. The intra signal 112 may be used in order to exploit spatial characteristics within a picture in an intra coding mode. The inter signal 114 may be used in order to exploit temporal characteristics between pictures in an inter coding mode. While in the intra coding mode, the intra signal 112 may be provided to the subtraction module 116 and the intra mode information 128 may be provided to an entropy coding module 130. While in the inter coding mode, the inter signal 114 may be provided to the subtraction module 116 and the inter mode information 138 may be provided to the entropy coding module 130.

Either the intra signal 112 or the inter signal 114 (depending on the mode) is subtracted from the source 106 at the subtraction module 116 in order to produce a prediction residual 118. The prediction residual 118 is provided to a transformation module 120. The transformation module 120 may compress the prediction residual 118 to produce a transformed signal 122 that is provided to a quantization module 124. The quantization module 124 quantizes the transformed signal 122 to produce transformed and quantized coefficients (TQCs) 126.

The TQCs 126 are provided to an entropy coding module 130 and an inverse quantization module 140. The inverse quantization module 140 performs inverse quantization on the TQCs 126 to produce an inverse quantized signal 142 that is provided to an inverse transformation module 144. The inverse transformation module 144 decompresses the inverse quantized signal 142 to produce a decompressed signal 146 that is provided to a reconstruction module 148.

The reconstruction module 148 may produce reconstructed data 150 based on the decompressed signal 146. For example, the reconstruction module 148 may reconstruct (modified) pictures. The reconstructed data 150 may be provided to a deblocking filter 152 and to the intra prediction module and reconstruction buffer 110. The deblocking filter 152 may produce a filtered signal 154 based on the reconstructed data 150.

The filtered signal 154 may be provided to a sample adaptive offset (SAO) module 156. The SAO module 156 may produce SAO information 158 that is provided to the entropy coding module 130 and an SAO signal 160 that is provided to an adaptive loop filter (ALF) 162. The ALF 162 produces an ALF signal 164 that is provided to the reference picture buffer 166. The ALF signal 164 may include data from one or more pictures that may be used as reference pictures.

The entropy coding module 130 may code the TQCs 126 to produce a bitstream 134. As described above, the TQCs 126 may be converted to a 1D array before entropy coding. Also, the entropy coding module 130 may code the TQCs 126 using CAVLC or CABAC. In particular, the entropy coding module 130 may code the TQCs 126 based on one or more of intra mode information 128, inter mode information 138 and SAO information 158. The bitstream 134 may include coded picture data.

The entropy coding module 130 may include a selective run-level coding (SRLC) module 132. The SRLC module 132 may determine whether to perform or skip run-level coding. In some configurations, the SRLC module 132 may determine whether to perform or skip run-level coding based on a quantization parameter (QP), resolution information, a block type, a block size and a trailing one (TR1). This may provide a benefit of increasing the accuracy of determining a run-level skip (flag) and improving coding performance. TR1 may be set to 1 (by the electronic device 102 (e.g., entropy coding module 130)) if the level of the last non-zero coefficient is equal to 1 and may be set to 0 otherwise.

Quantization, involved in video compression such as HEVC, is a lossy compression technique achieved by compressing a range of values to a single quantum value. The quantization parameter (QP) is a predefined scaling parameter used to perform the quantization based on both the quality of reconstructed video and compression ratio. The block type is defined in HEVC to represent the characteristics of a given block based on the block size and its color information. QP, resolution information and block type may be determined before entropy coding. For example, the electronic device 102 (e.g., the coder 108) may determine the QP, resolution information and block type, which may be provided to the entropy coding module 130 (e.g., the SRLC module 132).

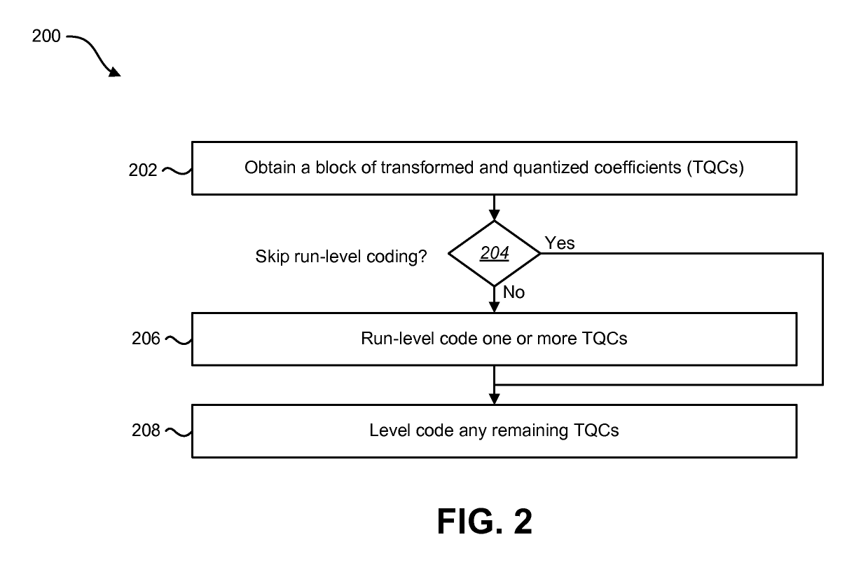

The entropy coding module 130 may determine the block size based on a block of TQCs 126. For example, block size may be the number of TQCs 126 along one dimension of the block of TQCs. In other words, the number of TQCs 126 in the block of TQCs may be equal to block size squared. For instance, block size may be determined as the square root of the number of TQCs 126 in the block of TQCs. Resolution may be defined as a pixel width by a pixel height. Resolution information may include a number of pixels for the width of a picture, for the height of a picture or both. Block size may be defined as the number of TQCs along one dimension of a 2D block of TQCs. The entropy coding module 130 may also determine the trailing one (TR1) based on the TQCs 126. TR1 may be set to 1 if the level of the last non-zero coefficient is equal to 1 and may be set to 0 otherwise. More detail on determining whether to perform or skip run-level coding is given below in connection with FIGS. 2, 3 and 4. In one configuration, the SRLC module 132 may determine whether to perform or skip run-level coding in accordance with the example given above.

In some configurations, the bitstream 134 may be transmitted to another electronic device. For example, the bitstream 134 may be provided to a communication interface, network interface, wireless transmitter, port, etc. For instance, the bitstream 134 may be transmitted to another electronic device via a Local Area Network (LAN), the Internet, a cellular phone base station, etc. The bitstream 134 may additionally or alternatively be stored in memory on the electronic device 102.

In some configurations, block classification information (e.g., a block classification indicator) may be inserted into the bitstream 134 by the coder 108. For example, the coder 108 may insert one or more bits or flags into the bitstream 134 for use in determining whether to skip run-level decoding. For instance, the coder 108 may insert two bits into the bitstream 134 (e.g., into a slice header) that indicate whether a block is classified as very high bit rate, high bit rate, mid bit rate or low bit rate. Additionally or alternatively, a bit (a resolution flag, for example) may be inserted into the bitstream 134 (e.g., into the slice header) that indicates whether a block is high resolution or low resolution.

FIG. 2 is a flow diagram illustrating one configuration of a method 200 for selective run-level coding (SRLC) on an electronic device 102. The electronic device 102 may obtain 202 a block of transformed and quantized coefficients (TQCs) 126. For example, the electronic device 102 may obtain 202 a block (e.g., a 2D array) of transformed and quantized coefficients (TQCs) 126. In some configurations, the electronic device 102 may convert the 2D array of TQCs 126 to a 1D array of TQCs 126.

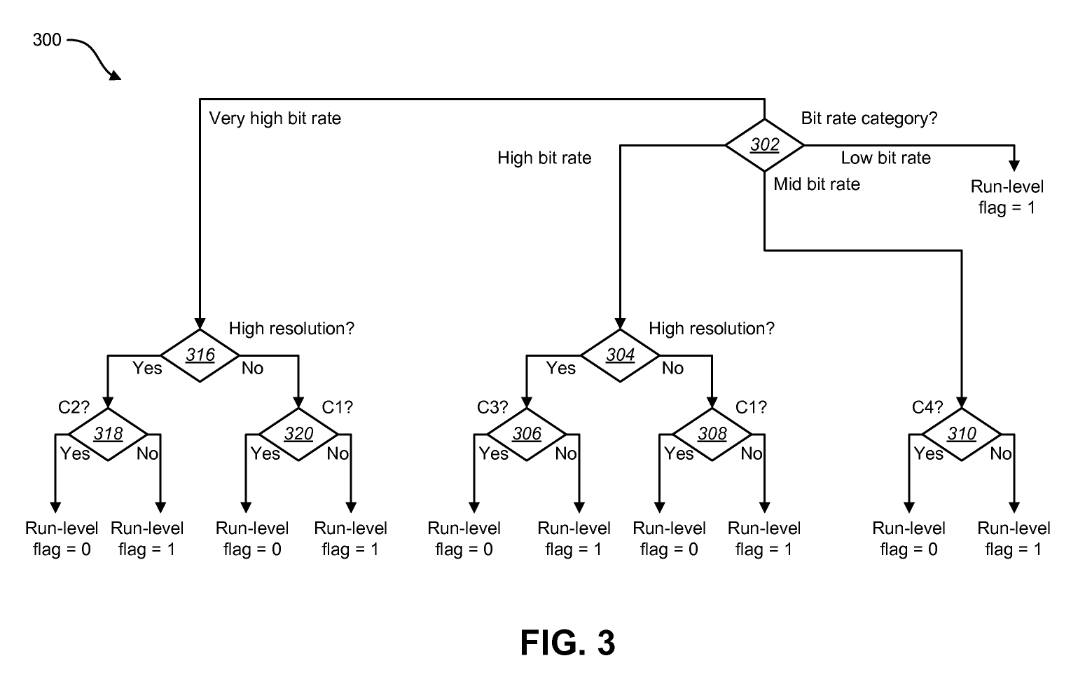

The electronic device 102 may determine 204 whether to skip run-level coding. In some configurations, this determination 204 may be based on one or more of a quantization parameter (QP), resolution information, a block type, a block size and a trailing one (TR1). One example of determining 204 whether to skip run-level coding is given in connection with FIG. 3 below.

If the electronic device 102 determines 204 to skip run-level coding, then the electronic device 102 may level code 208 any remaining TQCs 126. For example, the electronic device 102 may level code 208 remaining TQCs 126, if any, that are after a last non-zero coefficient in reverse scanning order from the block.

If the electronic device 102 determines 204 to not skip run-level coding, then the electronic device 102 may run-level code 206 one or more TQCs 126. For example, the electronic device 102 may run-level code 206 one or more TQCs 126 that are after a last non-zero coefficient in reverse scanning order from the block. The electronic device 102 may then level code 208 any remaining TQCs 126. For example, the electronic device 102 may level code 208 remaining TQCs 126, if any, that are after a last non-zero coefficient in reverse scanning order from the block and that remain after run-level coding 206.

FIG. 3 is a flow diagram illustrating one configuration of a method 300 for determining whether to skip run-level coding. For instance, the method 300 illustrated in FIG. 3 may be a more specific example of determining 204 whether to skip run-level coding illustrated in FIG. 2.

The electronic device 102 may determine 302 a bit rate category of a block. For example, the electronic device 102 may classify a block into a very high bit rate category, high bit rate category, mid bit rate category or low bit rate category. In some configurations, this determination 302 may be based on bit rate or a quantization parameter (QP) and one or more thresholds. In one configuration, three thresholds may be used, denoted TH1, TH2 and TH3. For example, if the QP<TH1 (indicating a very high bit rate, for instance), the electronic device 102 may determine 302 a very high bit rate category for the block or classify the block in a very high bit rate category. For instance, if TH1=16 and QP<16, the block may be classified in the very high bit rate category. If TH1≦QP<TH2 (indicating a high bit rate, for instance), the electronic device 102 may determine 302 a high bit rate category for the block or classify the block in a high bit rate category. For instance, if TH2=20 and 16≦QP<20, the block may be classified in the high bit rate category.

If TH2≦QP<TH3 (indicating a mid bit rate, for instance), the electronic device 102 may determine 302 a mid bit rate category for the block or classify the block in a mid bit rate category. For instance, if TH3=26 and 20≦QP<26, the block may be classified in the mid bit rate category. If QP is ≧TH3 (indicating a low bit rate, for instance), the electronic device 102 may determine 302 a low rate category for the block or classify the block in a low bit rate category. For instance, if TH1<TH2<TH3=26 and QP≧26, the block may be classified in the low bit rate category. In some configurations, the electronic device 102 may generate an indicator (using two bits, for example) that specifies whether a block is classified as very high bit rate, high bit rate, mid bit rate or low bit rate. This indicator may be inserted into a bitstream 134 (e.g., slice header) to be provided to a decoder.

If the electronic device 102 determines 302 a low bit rate category for a block, then the electronic device 102 may determine to not skip run-level coding. For example, the electronic device 102 may set a run-level flag to 1, indicating that run-level coding will not be skipped.

If the electronic device 102 determines 302 a very high bit rate category for a block, then the electronic device 102 may determine 316 whether the block is high resolution. In some configurations, the block may be classified as high resolution if the block is from a picture or image with a dimension that is greater than or equal to a resolution threshold. For example, the electronic device 102 may determine 316 that the block is high resolution if the block is from a picture with a width of 1280 pixels or more. In some configurations, the electronic device 102 may insert an indicator (e.g., resolution flag) into a bitstream 134 (e.g., slice header) to indicate whether a block is high resolution or low resolution to be provided to a decoder.

If the electronic device 102 determines 316 that a block is high resolution, the electronic device 102 may determine 318 whether a second condition (C2) is met. A second condition (C2) may be based on a TR1 value and whether the block type is equal to a block type value (e.g., 4). For instance, C2 may be met if (block type==4 && TR1==0). For example, the electronic device 102 may determine 318 if the block type of the block is equal to 4 and if TR1 is set to 0. If a block is a luminance block in a B slice and its block size is less than 16, then the corresponding block may be classified as block type==4. Here, a “B slice” generally represents a bi-directionally (e.g., forward and backward in picture display ordering) predicted picture. If C2 is met, then the electronic device 102 may determine to skip run-level coding. For example, the electronic device 102 may set a run-level flag to 0, indicating that run-level coding will be skipped. If C2 is not met, then the electronic device 102 may determine to not skip run-level coding. For example, the electronic device 102 may set a run-level flag to 1, indicating that run-level coding will not be skipped.

If the electronic device 102 determines 316 that a block is not high resolution, the electronic device 102 may determine 320 whether a first condition (C1) is met. For example, a first condition (C1) may be based on a TR1 value and whether a block size is equal to one or more block size values (e.g., 4 or 8). For instance, C1 may be met if ((block size==4 && TR1==0) 11 block size==8). For example, the electronic device 102 may determine 320 if the block size of the block is equal to 4 and if TR1 is set to 0 or if the block size is equal to 8. If C1 is met, then the electronic device 102 may determine to skip run-level coding. For example, the electronic device 102 may set a run-level flag to 0, indicating that run-level coding will be skipped. If C1 is not met, then the electronic device 102 may determine to not skip run-level coding. For example, the electronic device 102 may set a run-level flag to 1, indicating that run-level coding will not be skipped.

If the electronic device 102 determines 302 a high bit rate category for a block, then the electronic device 102 may determine 304 whether the block is high resolution. In some configurations, the block may be classified as high resolution if the block is from a picture or image with a dimension that is greater than or equal to a resolution threshold. For example, the electronic device 102 may determine 304 that the block is high resolution if the block is from a picture with a width of 1280 pixels or more. As described above, the electronic device 102 may insert an indicator (e.g., resolution flag) into a bitstream 134 to specify whether a block is high resolution or low resolution to be provided to a decoder.

If the electronic device 102 determines 304 that a block is high resolution, the electronic device 102 may determine 306 whether a third condition (C3) is met. A third condition (C3) may be based on a TR1 value and whether the block size is less than a block size value (e.g., 16). For instance, C3 may be met if (block size <16 && TR1==0). For example, the electronic device 102 may determine 306 if the block size of the block is less than 16 and if TR1 is set to 0. If C3 is met, then the electronic device 102 may determine to skip run-level coding. For example, the electronic device 102 may set a run-level flag to 0, indicating that run-level coding will be skipped. If C3 is not met, then the electronic device 102 may determine to not skip run-level coding. For example, the electronic device 102 may set a run-level flag to 1, indicating that run-level coding will not be skipped.

If the electronic device 102 determines 304 that a block is not high resolution, the electronic device 102 may determine 308 whether a first condition (C1) is met. For example, a first condition (C1) may be based on a TR1 value and whether a block size is equal to one or more block size values (e.g., 4 or 8). For instance, C1 may be met if ((block size==4 && TR1==0) 11 block size==8). For example, the electronic device 102 may determine 308 if the block size of the block is equal to 4 and if TR1 is set to 0 or if the block size is equal to 8. If C1 is met, then the electronic device 102 may determine to skip run-level coding. For example, the electronic device 102 may set a run-level flag to 0, indicating that run-level coding will be skipped. If C1 is not met, then the electronic device 102 may determine to not skip run-level coding. For example, the electronic device 102 may set a run-level flag to 1, indicating that run-level coding will not be skipped.

If the electronic device 102 determines 302 a mid bit rate category for a block, then the electronic device 102 may determine 310 whether a fourth condition (C4) is met. A fourth condition (C4) may be based on a TR1 value and whether the block size is equal to a block size value (e.g., 4). For instance, C4 may be met if (block size==4 && TR1==0). For example, the electronic device 102 may determine 310 if the block size of the block is equal to 4 and if TR1 is set to 0. If C4 is met, then the electronic device 102 may determine to skip run-level coding. For example, the electronic device 102 may set a run-level flag to 0, indicating that run-level coding will be skipped. If C4 is not met, then the electronic device 102 may determine to not skip run-level coding. For example, the electronic device 102 may set a run-level flag to 1, indicating that run-level coding will not be skipped. The method 300 may provide a benefit of achieving a more generalized CAVLC coding structure that may be efficient for all bit rates and also reduce computational complexity.

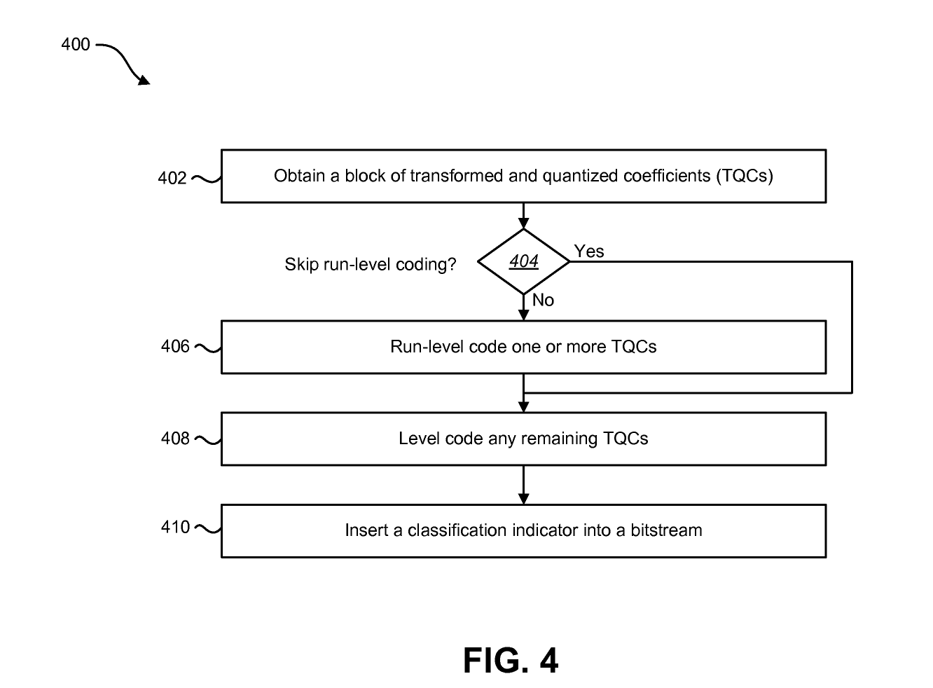

FIG. 4 is a flow diagram illustrating another configuration of a method 400 for selective run-level coding (SRLC) on an electronic device 102. The electronic device 102 may obtain 402 a block of transformed and quantized coefficients (TQCs) 126. For example, the electronic device 102 may obtain 402 a block (e.g., a 2D array) of transformed and quantized coefficients (TQCs) 126. In some configurations, the electronic device 102 may convert the 2D array of TQCs 126 to a 1D array of TQCs 126.

The electronic device 102 may determine 404 whether to skip run-level coding. In some configurations, this determination 404 may be based on one or more of a quantization parameter (QP), resolution information, a block type, a block size and a trailing one (TR1).

If the electronic device 102 determines 404 to skip run-level coding, then the electronic device 102 may level code 408 any remaining TQCs 126. For example, the electronic device 102 may level code 408 remaining TQCs 126, if any, that are after a last non-zero coefficient in reverse scanning order from the block.

If the electronic device 102 determines 404 to not skip run-level coding, then the electronic device 102 may run-level code 406 one or more TQCs 126. For example, the electronic device 102 may run-level code 406 one or more TQCs 126 that are after a last non-zero coefficient in reverse scanning order from the block. The electronic device 102 may then level code 408 any remaining TQCs 126. For example, the electronic device 102 may level code 408 remaining TQCs 126, if any, that are after a last non-zero coefficient in reverse scanning order from the block and that remain after run-level coding 406.

Whether or not the electronic device 102 determines 404 to skip run-level coding, the electronic device 102 may insert 410 a classification indicator into a bitstream. For example, coding the block of TQCs may result in a bitstream. The electronic device 102 may insert the classification indicator into the bitstream as overhead. In some configurations, the classification indicator may indicate a category for a block. Additionally or alternatively, the classification indicator may indicate a classification procedure to be employed by a decoder. The classification indicator may be provided or sent to a decoder in the bitstream. In some configurations, the classification indicator may specify a bit rate category (e.g., very high bit rate, high bit rate, mid bit rate or low bit rate) and/or a resolution (e.g., high resolution or low resolution). For instance, three bits may be inserted into a slice header for a block, where two bits are used to specify the bit rate category and one bit is used to specify whether the block is high resolution or low resolution.

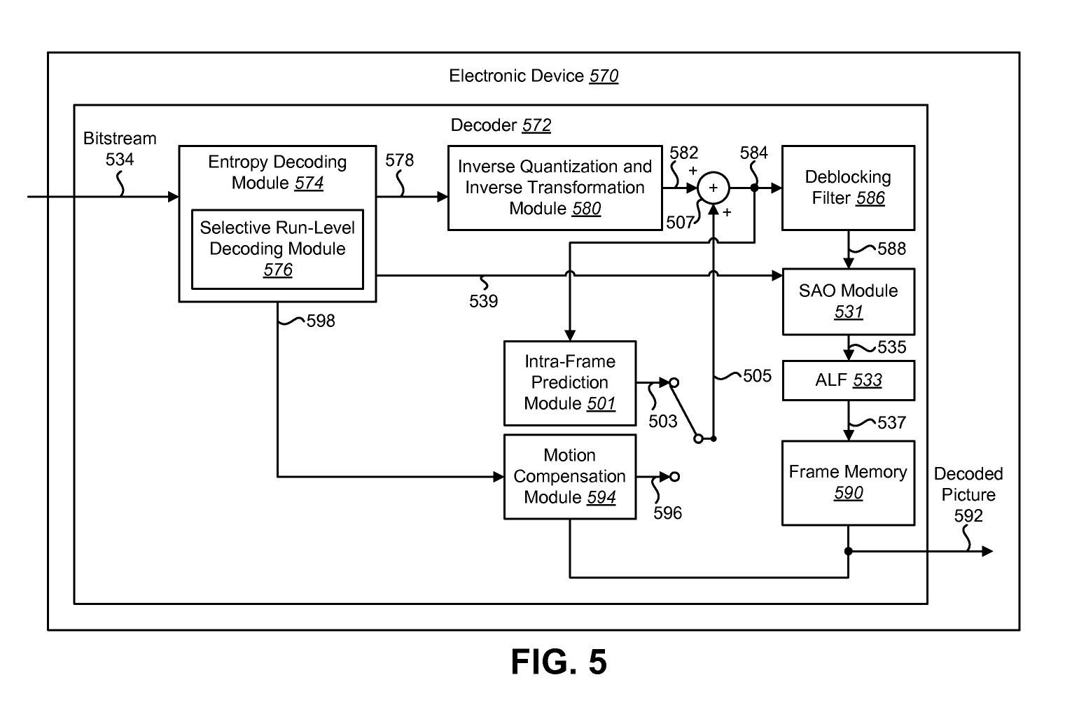

FIG. 5 is a block diagram illustrating one configuration of an electronic device 570 in which systems and methods for selected run-level decoding may be implemented. In some configurations, the decoder 572 may be a high-efficiency video coding (HEVC) decoder. The decoder 572 and one or more of the elements illustrated as included in the decoder 572 may be implemented in hardware, software or a combination of both. The decoder 572 may receive a bitstream 534 (e.g., one or more coded pictures included in the bitstream 534) for decoding. In some configurations, the received bitstream 534 may include received overhead information, such as a received slice header, received picture parameter set (PPS), received buffer description information, classification indicator, etc. In some configurations, the classification indicator may be included in each slice header. The classification indicator is may also represent the QP and resolution information in some configurations. Other information such as block size, block type, and TR1 may be automatically generated during encoding/decoding process. For example, the electronic device 570 (e.g., decoder 572) may generate the block size, block type and TR1, which may be provided to the entropy decoding module 574 (e.g., selective run-level decoding module 576). TR1 may be set to 1 if the level of the last non-zero coefficient is equal to 1 and may be set to 0 otherwise.

Received symbols (e.g., encoded TQCs) from the bitstream 534 may be entropy decoded by an entropy decoding module 574. This may produce a motion information signal 598 and decoded transformed and quantized coefficients (TQCs) 578.

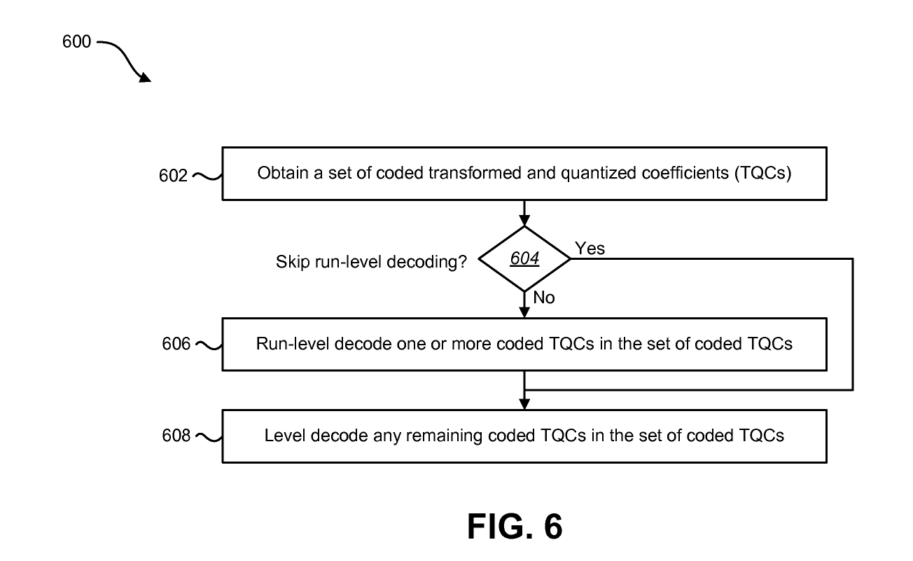

The entropy decoding module 574 may include a selective run-level decoding module 576. The selective run-level decoding module 576 may determine whether to skip run-level decoding. In some configurations, this determination may be based on one or more of a quantization parameter (QP), resolution information, a block type, a block size, a trailing one (TR1) and a classification indicator. More detail is given in connection with FIGS. 6, 7 and 8 below.

The motion information signal 598 may be combined with a portion of a decoded picture 592 from a frame memory 590 at a motion compensation module 594, which may produce an inter-frame prediction signal 596. The decoded transformed and quantized coefficients (TQCs) 578 may be inverse quantized and inverse transformed by an inverse quantization and inverse transformation module 580, thereby producing a decoded residual signal 582. The decoded residual signal 582 may be added to a prediction signal 505 by a summation module 507 to produce a combined signal 584. The prediction signal 505 may be a signal selected from either the inter-frame prediction signal 596 produced by the motion compensation module 594 or an intra-frame prediction signal 503 produced by an intra-frame prediction module 501. In some configurations, this signal selection may be based on (e.g., controlled by) the bitstream 534.

The intra-frame prediction signal 503 may be predicted from previously decoded information from the combined signal 584 (in the current frame, for example). The combined signal 584 may also be filtered by a deblocking filter 586. The resulting filtered signal 588 may be provided to a sample adaptive offset (SAO) module 531. Based on the filtered signal 588 and information 539 from the entropy decoding module 574, the SAO module 531 may produce an SAO signal 535 that is provided to an adaptive loop filter (ALF) 533. The ALF 533 produces an ALF signal 537 that is provided to the frame memory 590. The ALF signal 537 may include data from one or more pictures that may be used as reference pictures. The ALF signal 537 may be written to frame memory 590. The resulting ALF signal 537 may include a decoded picture.

The frame memory 590 may include a decoded picture buffer (DPB). The frame memory 590 may also include overhead information corresponding to the decoded pictures. For example, the frame memory 590 may include slice headers, picture parameter set (PPS) information, cycle parameters, buffer description information, etc. One or more of these pieces of information may be signaled from a coder (e.g., coder 108).

The frame memory 590 may provide one or more decoded pictures 592 to the motion compensation module 594. Furthermore, the frame memory 590 may provide one or more decoded pictures 592, which may be output from the decoder 572. The one or more decoded pictures 592 may be presented on a display, stored in memory or transmitted to another device, for example.

FIG. 6 is a flow diagram illustrating one configuration of a method 600 for selective run-level decoding on an electronic device 570. The electronic device 570 may obtain 602 a set of coded transformed and quantized coefficients (TQCs). For example, the electronic device 570 may obtain 602 a set of coded TQCs from a bitstream 534. In some configurations, the set of coded TQCs may correspond to a block of TQCs 126 that was coded by a coder 108.

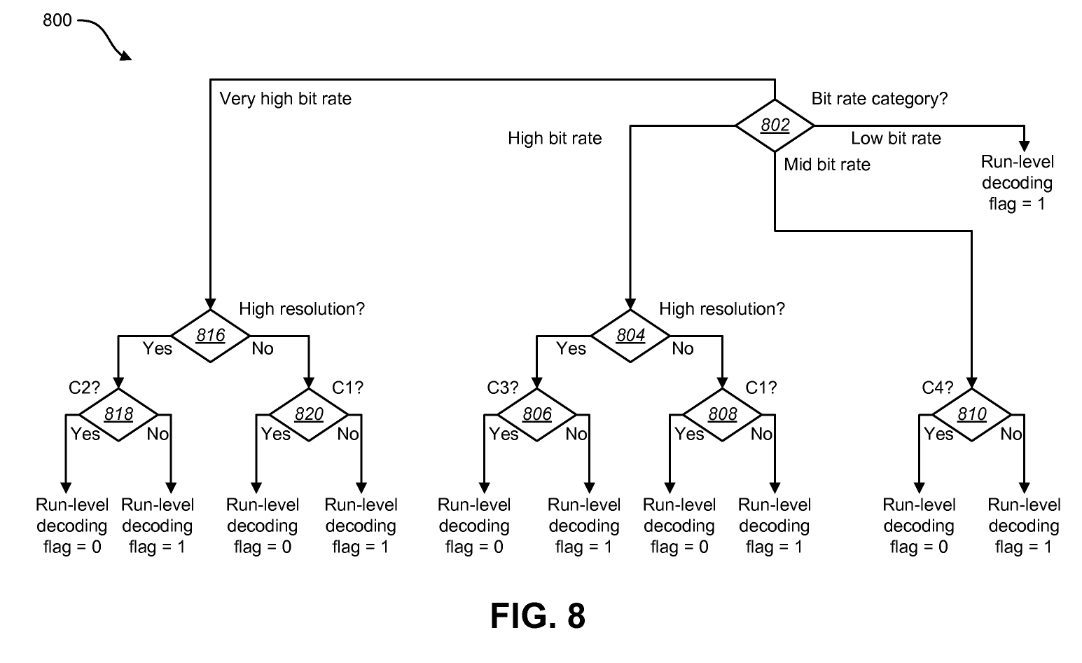

The electronic device 570 may determine 604 whether to skip run-level decoding. In some configurations, this determination 604 may be based on one or more of a quantization parameter (QP), resolution information, a block type, a block size, a trailing one (TR1) and a classification indicator. Examples of determining 604 whether to skip run-level decoding are given in connection with FIG. 8 below.

If the electronic device 570 determines 604 to skip run-level decoding, then the electronic device 570 may level decode 608 any remaining coded TQCs in the set of coded TQCs. For example, the electronic device 570 may level decode 608 remaining TQCs 126, if any, in the set.

If the electronic device 570 determines 604 to not skip run-level decoding, then the electronic device 570 may run-level decode 606 one or more coded TQCs in the set of coded TQCs. The electronic device 570 may then level decode 608 any remaining TQCs 126 in the set. For example, the electronic device 570 may level decode 608 remaining coded TQCs 126, if any, that remain after run-level decoding 606.

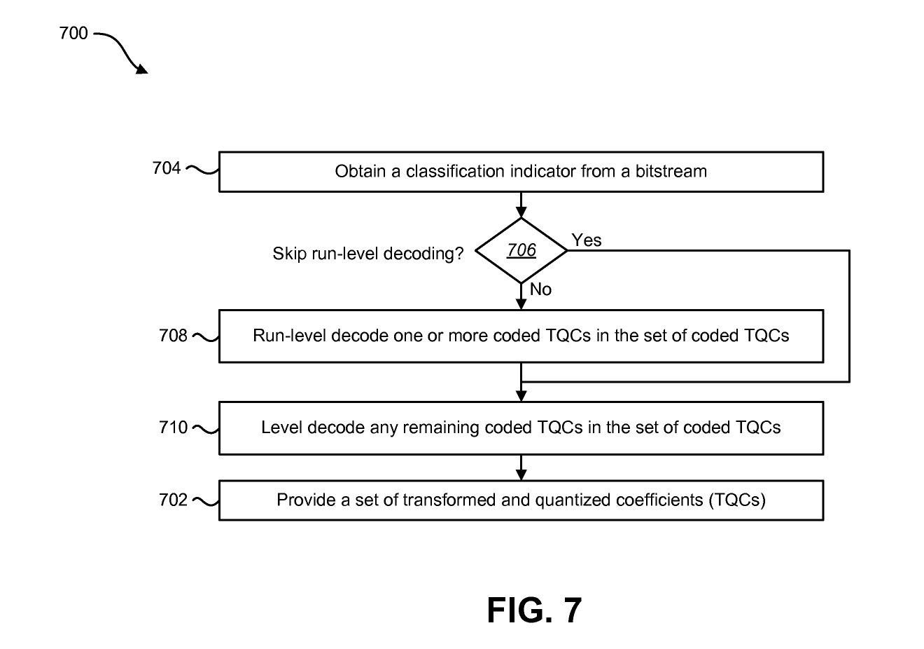

FIG. 7 is a flow diagram illustrating another configuration of a method 700 for selective run-level decoding on an electronic device 570. The electronic device 570 may obtain a bitstream. For example, the electronic device 570 may obtain a set of coded TQCs from a bitstream 534. In some configurations, the set of coded TQCs may correspond to a block of TQCs 126 that was coded by a coder 108.

The electronic device 570 may obtain 704 a classification indicator from a bitstream 534. For example, the electronic device 570 may receive a classification indicator from a coder. In some configurations, the classification indicator may include information that specifies a bit rate. For instance, the classification indicator may include two bits that specify whether the set of coded TQCs is very high bit rate, high bit rate, mid bit rate or low bit rate. Additionally or alternatively, the classification indicator may include information that specifies a whether the set of coded TQCs is high resolution or low resolution. For example, the classification indicator may include one bit (e.g., a resolution flag) that indicates whether the set of coded TQCs is high resolution or low resolution. In some configurations, the classification indicator may include the bit that indicates high or low resolution only if the set of coded TQCs is very high bit rate or high bit rate.

The electronic device 570 may determine 706 whether to skip run-level decoding. In some configurations, this determination 706 may be based on one or more of a quantization parameter (QP), resolution information, a block type, a block size, a trailing one (TR1) and/or the classification indicator. Examples of determining 706 whether to skip run-level decoding are given in connection with FIG. 8 below.

If the electronic device 570 determines 706 to skip run-level decoding, then the electronic device 570 may level decode 710 any remaining coded TQCs in the set of coded TQCs. For example, the electronic device 570 may level decode 710 remaining TQCs 126, if any, in the set.

If the electronic device 570 determines 706 to not skip run-level decoding, then the electronic device 570 may run-level decode 708 one or more coded TQCs in the set of coded TQCs. The electronic device 570 may then level decode 710 any remaining TQCs 126 in the set. For example, the electronic device 570 may level decode 710 remaining coded TQCs 126, if any, that remain after run-level decoding 708.

The electronic device 570 may provide 702 a set of transformed and quantized coefficients (TQCs). For example, this method 700 may produce a block of decoded TQCs. The TQCs may be used to produce a decoded picture.

FIG. 8 is a flow diagram illustrating examples of a method 800 for determining whether to skip run-level decoding. For instance, the method 800 illustrated in FIG. 8 may be a more specific example of determining 604, 706 whether to skip run-level decoding illustrated in FIG. 6 or FIG. 7.

The electronic device 570 may determine 802 a bit rate category of a set of coded transformed and quantized coefficients (TQCs) to be decoded and arranged into a block of TQCs 578. For example, the electronic device 570 may classify a set into a very high bit rate category, high bit rate category, mid bit rate category or low bit rate category. In some configurations, this determination 802 may be based on bit rate or a quantization parameter (QP) and one or more thresholds. In one configuration, three thresholds may be used, denoted TH1, TH2 and TH3. For example, if the QP<TH1 (indicating a very high bit rate, for instance), the electronic device 570 may determine 802 a very high bit rate category for the set or classify the set in a very high bit rate category. For instance, if TH1=16 and QP<16, the set may be classified in the very high bit rate category. If TH1≦QP<TH2 (indicating a high bit rate, for instance), the electronic device 570 may determine 802 a high bit rate category for the set or classify the set in a high bit rate category. For instance, if TH2=20 and 16≦QP<20, the set may be classified in the high bit rate category.

If TH2≦QP<TH3 (indicating a mid bit rate, for instance), the electronic device 570 may determine 802 a mid bit rate category for the set or classify the set in a mid bit rate category. For instance, if TH3=26 and 20≦QP<26, the set may be classified in the mid bit rate category. If QP is ≧TH3 (indicating a low bit rate, for instance), the electronic device 570 may determine 802 a low rate category for the set or classify the set in a low bit rate category. For instance, if TH1<TH2<TH3=26 and QP≧26, the set may be classified in the low bit rate category.

In some alternate configurations, the electronic device 570 may determine 802 the bit rate category of the set based on a classification indicator. For example, the electronic device 570 may receive a classification indicator in the bitstream 534 that specifies whether the set is very high bit rate, high bit rate, mid bit rate or low bit rate (using two bits, for instance). For instance, the electronic device 570 may determine 802 or classify the bit rate category of the set as specified by the classification indicator.

If the electronic device 570 determines 802 a low bit rate category for a set, then the electronic device 570 may determine to not skip run-level decoding. For example, the electronic device 570 may set a run-level decoding flag to 1, indicating that run-level decoding will not be skipped.

If the electronic device 570 determines 802 a very high bit rate category for a set, then the electronic device 570 may determine 816 whether the set is high resolution. In some configurations, the set may be classified as high resolution if the set corresponds to a picture or image with a dimension that is greater than or equal to a resolution threshold. For example, the electronic device 570 may determine 816 that the set is high resolution if the set corresponds to a picture with a width of 1280 pixels or more. The resolution information used to make this determination 802 may be derived from the bitstream 534 (by determining the resolution of a decoded frame for example). Alternatively, this determination 816 may be based on a classification indicator. For example, a classification indicator may be obtained from the bitstream 534 (in a slice header, for example) that specifies whether the set is high resolution or low resolution. For instance, the classification indicator may include a bit (e.g., resolution flag) that specifies whether the set is high resolution or low resolution. In a configuration where the classification indicator is used in this way, the electronic device 570 may determine 816 whether the set is high resolution according to the classification indicator.

If the electronic device 570 determines 816 that a set is high resolution, the electronic device 570 may determine 818 whether a second condition (C2) is met. For example, the electronic device 570 may determine 818 whether the set may be decoded into a block that meets C2. A second condition (C2) may be based on a TR1 value and whether the block type is equal to a block type value (e.g., 4). For instance, C2 may be met if (block type==4 && TR1==0). For example, the electronic device 570 may determine 818 if the block type of the block is equal to 4 and if TR1 is set to 0. If a block is a luminance block in a B slice and its block size is less than 16, then the corresponding block may be classified as block type==4. Here, a “B slice” generally represents a bi-directionally (e.g., forward and backward in picture display ordering) predicted picture. If C2 is met, then the electronic device 570 may determine to skip run-level decoding. For example, the electronic device 570 may set a run-level decoding flag to 0, indicating that run-level decoding will be skipped. If C2 is not met, then the electronic device 570 may determine to not skip run-level decoding. For example, the electronic device 570 may set a run-level decoding flag to 1, indicating that run-level decoding will not be skipped.

If the electronic device 570 determines 816 that a set is not high resolution, the electronic device 570 may determine 820 whether a first condition (C1) is met. For example, the electronic device 570 may determine 820 whether the set may be decoded into a block that meets C1. A first condition (C1) may be based on a TR1 value and whether a block size is equal to one or more block size values (e.g., 4 or 8). For instance, C1 may be met if ((block size==4 && TR1==0)∥block size==8). For example, the electronic device 570 may determine 820 if the block size of the block is equal to 4 and if TR1 is set to 0 or if the block size is equal to 8. If C1 is met, then the electronic device 570 may determine to skip run-level decoding. For example, the electronic device 570 may set a run-level decoding flag to 0, indicating that run-level decoding will be skipped. If C1 is not met, then the electronic device 570 may determine to not skip run-level decoding. For example, the electronic device 570 may set a run-level decoding flag to 1, indicating that run-level decoding will not be skipped.

If the electronic device 570 determines 802 a high bit rate category for a set, then the electronic device 570 may determine 804 whether the set is high resolution. In some configurations, the set may be classified as high resolution if the set corresponds to a picture or image with a dimension that is greater than or equal to a resolution threshold. For example, the electronic device 570 may determine 804 that the set is high resolution if the set corresponds to a picture with a width of 1280 pixels or more. The resolution information used to make this determination 802 may be derived from the bitstream 534 (by determining the resolution of a decoded frame for example). Alternatively, this determination 804 may be based on a classification indicator. For example, a classification indicator may be obtained from the bitstream 534 (in a slice header, for example) that specifies whether the set is high resolution or low resolution. For instance, the classification indicator may include a bit (e.g., resolution flag) that specifies whether the set is high resolution or low resolution. In a configuration where the classification indicator is used in this way, the electronic device 570 may determine 816 whether the set is high resolution according to the classification indicator.

If the electronic device 570 determines 804 that a set is high resolution, the electronic device 570 may determine 806 whether a third condition (C3) is met. For example, the electronic device 570 may determine 806 whether the set may be decoded into a block that meets C3. A third condition (C3) may be based on a TR1 value and whether the block size is less than a block size value (e.g., 16). For instance, C3 may be met if (block size <16 && TR1==0). For example, the electronic device 570 may determine 806 if the block size of the block is less than 16 and if TR1 is set to 0. If C3 is met, then the electronic device 570 may determine to skip run-level decoding. For example, the electronic device 570 may set a run-level decoding flag to 0, indicating that run-level decoding will be skipped. If C3 is not met, then the electronic device 570 may determine to not skip run-level decoding. For example, the electronic device 570 may set a run-level decoding flag to 1, indicating that run-level decoding will not be skipped.

If the electronic device 570 determines 804 that a set is not high resolution, the electronic device 570 may determine 808 whether a first condition (C1) is met. For example, the electronic device 570 may determine 808 whether the set may be decoded into a block that meets C1. A first condition (C1) may be based on a TR1 value and whether a block size is equal to one or more block size values (e.g., 4 or 8). For instance, C1 may be met if ((block size==4 && TR1==0)∥block size==8). For example, the electronic device 570 may determine 808 if the block size of the block is equal to 4 and if TR1 is set to 0 or if the block size is equal to 8. If C1 is met, then the electronic device 570 may determine to skip run-level decoding. For example, the electronic device 570 may set a run-level decoding flag to 0, indicating that run-level decoding will be skipped. If C1 is not met, then the electronic device 570 may determine to not skip run-level decoding. For example, the electronic device 570 may set a run-level decoding flag to 1, indicating that run-level decoding will not be skipped.

If the electronic device 570 determines 802 a mid bit rate category for a set, then the electronic device 570 may determine 810 whether a fourth condition (C4) is met. For example, the electronic device 570 may determine 810 whether the set may be decoded into a block that meets C4. A fourth condition (C4) may be based on a TR1 value and whether the block size is equal to a block size value (e.g., 4). For instance, C4 may be met if (block size==4 && TR1==0). For example, the electronic device 570 may determine 810 if the block size of the block is equal to 4 and if TR1 is set to 0. If C4 is met, then the electronic device 570 may determine to skip run-level decoding. For example, the electronic device 570 may set a run-level decoding flag to 0, indicating that run-level decoding will be skipped. If C4 is not met, then the electronic device 570 may determine to not skip run-level decoding. For example, the electronic device 570 may set a run-level decoding flag to 1, indicating that run-level decoding will not be skipped. The method 800 may provide a benefit of achieving a more generalized CAVLC coding structure that may be efficient for all bit rates and also reduce computational complexity.

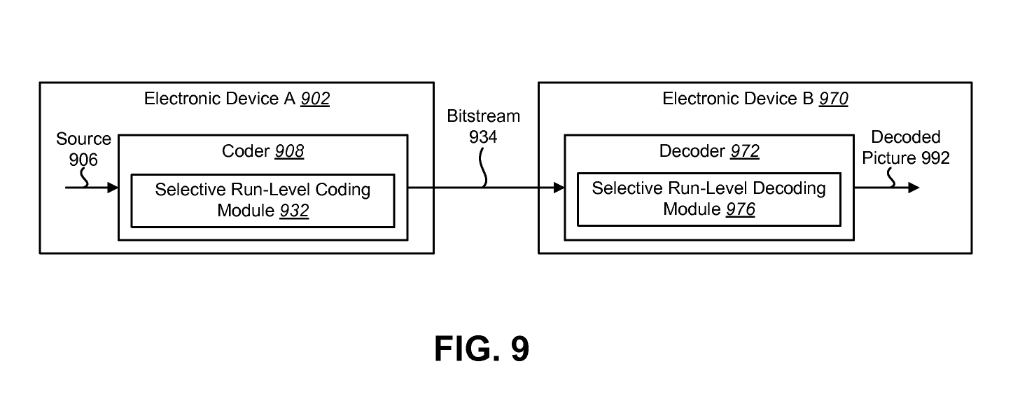

FIG. 9 is a block diagram illustrating one example of a coder 908 and a decoder 972. In this example, electronic device A 902 and electronic device B 970 are illustrated. However, it should be noted that the features and functionality described in relation to electronic device A 902 and electronic device B 970 may be combined into a single electronic device in some configurations.

Electronic device A 902 includes a coder 908. The coder 908 may be implemented in hardware, software or a combination of both. In one configuration, the coder 908 may be a high-efficiency video coding (HEVC) coder. Electronic device A 902 may obtain a source 906. In some configurations, the source 906 may be captured on electronic device A 902 using an image sensor, retrieved from memory or received from another electronic device.

The coder 908 may code the source 906 to produce a bitstream 934. For example, the coder 908 may code a series of pictures (e.g., video) in the source 906. The coder 908 may be similar to the coder 108 described above in connection with FIG. 1. The coder 908 may be configured to perform one or more of the methods 200, 300, 400 described in connection with FIGS. 2, 3 and 4 above. The coder 908 may include a selective run-level coding (SRLC) module 932. The selective run-level coding module 932 may be similar to the selective run-level coding module 132 described in connection with FIG. 1. The selective run-level coding module 932 may perform the method 300 described above in connection with FIG. 3.

The bitstream 934 may include coded picture data based on the source 906. In some configurations, the bitstream 934 may also include overhead data, such as slice header information, PPS information, one or more classification indicators, etc. As additional pictures in the source 906 are coded, the bitstream 934 may include one or more coded pictures.

The bitstream 934 may be provided to a decoder 972. In one example, the bitstream 934 may be transmitted to electronic device B 970 using a wired or wireless link. In some cases, this may be done over a network, such as the Internet or a Local Area Network (LAN). As illustrated in FIG. 9, the decoder 972 may be implemented on electronic device B 970 separately from the coder 908 on electronic device A 902. However, it should be noted that the coder 908 and decoder 972 may be implemented on the same electronic device in some configurations. In an implementation where the coder 908 and decoder 972 are implemented on the same electronic device, for instance, the bitstream 934 may be provided over a bus to the decoder 972 or stored in memory for retrieval by the decoder 972.

The decoder 972 may be implemented in hardware, software or a combination of both. In one configuration, the decoder 972 may be a high-efficiency video coding (HEVC) decoder. The decoder 972 may be similar to the decoder 572 described above in connection with FIG. 5. The decoder 972 may be configured to perform one or more of the methods 600, 700, 800 described above in connection with FIGS. 6-8. The decoder 972 may receive (e.g., obtain) the bitstream 934. The decoder 972 may generate a decoded picture 992 (e.g., one or more decoded pictures 992) based on the bitstream 934. The decoded picture 992 may be displayed, played back, stored in memory or transmitted to another device, for example.

The decoder 972 may include a selective run-level decoding module 976. The selective run-level decoding module 976 may be similar to the selective run-level decoding module 576 described above in connection with FIG. 5. In some configurations, the selective run-level decoding module 976 may be configured to perform the method 800 described above in connection with FIG. 8.

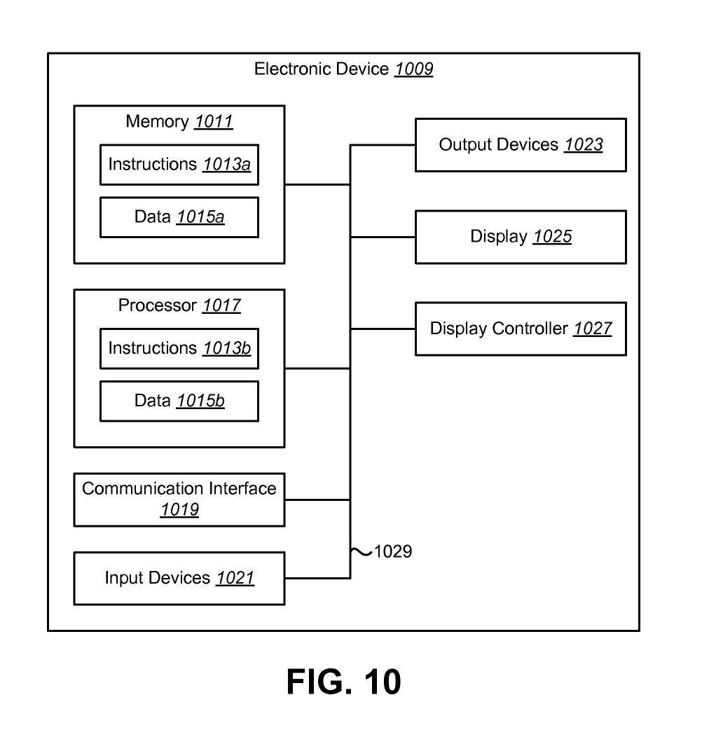

FIG. 10 illustrates various components that may be utilized in an electronic device 1009. The electronic device 1009 may be implemented as one or more of the electronic devices 102, 570, 902, 970 described previously. For example, the electronic device 1009 may be implemented as the electronic device 102 described above in connection with FIG. 1, as the electronic device 570 described above in connection with FIG. 5 or both.

The electronic device 1009 includes a processor 1017 that controls operation of the electronic device 1009. The processor 1017 may also be referred to as a CPU. Memory 1011, which may include both read-only memory (ROM), random access memory (RAM) or any type of device that may store information, provides instructions 1013a (e.g., executable instructions) and data 1015a to the processor 1017. A portion of the memory 1011 may also include non-volatile random access memory (NVRAM). The memory 1011 may be in electronic communication with the processor 1017.

Instructions 1013b and data 1015b may also reside in the processor 1017. Instructions 1013b and/or data 1015b loaded into the processor 1017 may also include instructions 1013a and/or data 1015a from memory 1011 that were loaded for execution or processing by the processor 1017. The instructions 1013b may be executed by the processor 1017 to implement one or more of the systems and methods (e.g., one or more of the methods 200, 300, 400, 600, 700, 800) disclosed herein.

The electronic device 1009 may include one or more communication interfaces 1019 for communicating with other electronic devices. The communication interfaces 1019 may be based on wired communication technology, wireless communication technology, or both. Examples of communication interfaces 1019 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 1009 may include one or more output devices 1023 and one or more input devices 1021. Examples of output devices 1023 include a speaker, printer, etc. One type of output device that may be included in an electronic device 1009 is a display device 1025. Display devices 1025 used with configurations disclosed herein may utilize any suitable image projection technology, such as a cathode ray tube (CRT), liquid crystal display (LCD), light-emitting diode (LED), gas plasma, electroluminescence or the like. A display controller 1027 may be provided for converting data stored in the memory 1011 into text, graphics, and/or moving images (as appropriate) shown on the display 1025. Examples of input devices 1021 include a keyboard, mouse, microphone, remote control device, button, joystick, trackball, touchpad, touchscreen, lightpen, etc.

The various components of the electronic device 1009 are coupled together by a bus system 1029, which may include a power bus, a control signal bus and a status signal bus, in addition to a data bus. However, for the sake of clarity, the various buses are illustrated in FIG. 10 as the bus system 1029. The electronic device 1009 illustrated in FIG. 10 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An electronic device configured for selective run-level coding (SRLC), comprising:
a processor;
memory in electronic communication with the processor;
instructions stored in the memory, the instructions being executable to:
obtain a block of transformed and quantized coefficients (TQCs);
determine whether to skip run-level coding;
level code any remaining TQCs if it is determined to skip run-level coding;
run-level code one or more TQCs if it is determined not to skip run-level coding; and
level code any remaining TQCs if it is determined not to skip run-level coding.

2. The electronic device of claim 1, wherein determining whether to skip run-level coding is based on at least one of a quantization parameter (QP), resolution information, a block type, a block size and a trailing one (TR1).

3. The electronic device of claim 1, wherein determining whether to skip run-level coding comprises:
determining a bit rate category of the block based on a quantization parameter (QP); and
determining to not skip run-level coding if a low bit rate category is determined.

4. The electronic device of claim 3, wherein if a very high bit rate category is determined, then the instructions are executable to:
determine whether the block is high resolution;
determine whether a second condition is met if the block is high resolution;
determine to skip run-level coding if the second condition is met;
determine to not skip run-level coding if the second condition is not met;
determine whether a first condition is met if the block is not high resolution;
determine to skip run-level coding if the first condition is met; and
determine to not skip run-level coding if the first condition is not met.

5. The electronic device of claim 3, wherein if a high bit rate category is determined, then the instructions are executable to:
determine whether the block is high resolution;
determine whether a third condition is met if the block is high resolution;
determine to skip run-level coding if the third condition is met;
determine to not skip run-level coding if the third condition is not met;
determine whether a first condition is met if the block is not high resolution;
determine to skip run-level coding if the first condition is met; and
determine to not skip run-level coding if the first condition is not met.

6. The electronic device of claim 3, wherein if a mid bit rate category is determined, then the instructions are executable to:
determine whether a fourth condition is met;
determine to skip run-level coding if the fourth condition is met; and
determine to not skip run-level coding if the fourth condition is not met.

7. The electronic device of claim 1, wherein the block is high resolution if the block is from a picture with a width that is greater than or equal to 1280 pixels.

8. The electronic device of claim 3, wherein a very high bit rate category is determined if the QP is less than a first threshold, a high bit rate category is determined if the first threshold is less than or equal to the QP and if the QP is less than a second threshold, a mid bit rate category is determined if the second threshold is less than or equal to the QP and if the QP is less than a third threshold and the low bit rate category is determined if the QP is greater than or equal to the third threshold.

9. The electronic device of claim 1, wherein the instructions are further executable to insert a classification indicator into a bitstream.

10. An electronic device configured for selective run-level decoding, comprising:
a processor;
memory in electronic communication with the processor;
instructions stored in the memory, the instructions being executable to:
obtain a set of coded transformed and quantized coefficients (TQCs);
determine whether to skip run-level decoding;
level decode any remaining coded TQCs in the set of coded TQCs if it is determined to skip run-level decoding;
run-level decode one or more TQCs in the set of coded TQCs if it is determined not to skip run-level decoding; and
level decode any remaining TQCs if it is determined not to skip run-level decoding.

11. The electronic device of claim 10, wherein determining whether to skip run-level decoding is based on at least one of a quantization parameter (QP), resolution information, a block type, a block size, a trailing one (TR1) and a classification indicator.

12. The electronic device of claim 10, wherein determining whether to skip run-level decoding comprises:
determining a bit rate category of the set; and
determining to not skip run-level decoding if a low bit rate category is determined.

13. The electronic device of claim 12, wherein if a very high bit rate category is determined, then the instructions are executable to:
determine whether the set is high resolution;
determine whether a second condition is met if the set is high resolution;
determine to skip run-level decoding if the second condition is met;
determine to not skip run-level decoding if the second condition is not met;
determine whether a first condition is met if the set is not high resolution;
determine to skip run-level decoding if the first condition is met; and
determine to not skip run-level decoding if the first condition is not met.

14. The electronic device of claim 12, wherein if a high bit rate category is determined, then the instructions are executable to:
determine whether the set is high resolution;
determine whether a third condition is met if the set is high resolution;
determine to skip run-level decoding if the third condition is met;
determine to not skip run-level decoding if the third condition is not met;
determine whether a first condition is met if the set is not high resolution;
determine to skip run-level decoding if the first condition is met; and
determine to not skip run-level decoding if the first condition is not met.

15. The electronic device of claim 12, wherein if a mid bit rate category is determined, then the instructions are executable to:
determine whether a fourth condition is met;
determine to skip run-level decoding if the fourth condition is met; and
determine to not skip run-level decoding if the fourth condition is not met.

16. The electronic device of claim 12, wherein determining whether to skip run-level decoding is based on a classification indicator obtained from a bitstream.

17. A method for selective run-level coding (SRLC) on an electronic device, comprising:
obtaining a block of transformed and quantized coefficients (TQCs);
determining whether to skip run-level coding;
level coding any remaining TQCs if it is determined to skip run-level coding;
run-level coding one or more TQCs if it is determined not to skip run-level coding; and
level coding any remaining TQCs if it is determined not to skip run-level coding.

18. The method of claim 17, wherein determining whether to skip run-level coding is based on at least one of a quantization parameter (QP), resolution information, a block type, a block size and a trailing one (TR1).

19. The method of claim 17, wherein determining whether to skip run-level coding comprises:
determining a bit rate category of the block based on a quantization parameter (QP); and
determining to not skip run-level coding if a low bit rate category is determined.

20. The method of claim 19, wherein if a very high bit rate category is determined, then the method comprises:
determining whether the block is high resolution;
determining whether a second condition is met if the block is high resolution;
determining to skip run-level coding if the second condition is met;
determining to not skip run-level coding if the second condition is not met;
determining whether a first condition is met if the block is not high resolution;
determining to skip run-level coding if the first condition is met; and
determining to not skip run-level coding if the first condition is not met.

21. The method of claim 19, wherein if a high bit rate category is determined, then the method comprises:
determining whether the block is high resolution;
determining whether a third condition is met if the block is high resolution;
determining to skip run-level coding if the third condition is met;
determining to not skip run-level coding if the third condition is not met;
determining whether a first condition is met if the block is not high resolution;
determining to skip run-level coding if the first condition is met; and
determining to not skip run-level coding if the first condition is not met.

22. The method of claim 19, wherein if a mid bit rate category is determined, then the method comprises:
determining whether a fourth condition is met;
determining to skip run-level coding if the fourth condition is met; and
determining to not skip run-level coding if the fourth condition is not met.

23. The method of claim 17, wherein the block is high resolution if the block is from a picture with a width that is greater than or equal to 1280 pixels.

24. The method of claim 19, wherein a very high bit rate category is determined if the QP is less than a first threshold, a high bit rate category is determined if the first threshold is less than or equal to the QP and if the QP is less than a second threshold, a mid bit rate category is determined if the second threshold is less than or equal to the QP and if the QP is less than a third threshold and the low bit rate category is determined if the QP is greater than or equal to the third threshold.

25. The method of claim 17, wherein the method further comprises inserting a classification indicator into a bitstream.

26. A method configured for selective run-level decoding on an electronic device, comprising:
obtaining a set of coded transformed and quantized coefficients (TQCs);
determining whether to skip run-level decoding;
level decoding any remaining coded TQCs in the set of coded TQCs if it is determined to skip run-level decoding;
run-level decoding one or more TQCs in the set of coded TQCs if it is determined not to skip run-level decoding; and
level decoding any remaining TQCs if it is determined not to skip run-level decoding.

27. The method of claim 26, wherein determining whether to skip run-level decoding is based on at least one of a quantization parameter (QP), resolution information, a block type, a block size, a trailing one (TR1) and a classification indicator.

28. The method of claim 26, wherein determining whether to skip run-level decoding comprises:
determining a bit rate category of the set; and
determining to not skip run-level decoding if a low bit rate category is determined.

29. The method of claim 28, wherein if a very high bit rate category is determined, then the method comprises:
determining whether the set is high resolution;
determining whether a second condition is met if the set is high resolution;
determining to skip run-level decoding if the second condition is met;
determining to not skip run-level decoding if the second condition is not met;
determining whether a first condition is met if the set is not high resolution;
determining to skip run-level decoding if the first condition is met; and
determining to not skip run-level decoding if the first condition is not met.

30. The method of claim 28, wherein if a high bit rate category is determined, then the method comprises:
determining whether the set is high resolution;
determining whether a third condition is met if the set is high resolution;
determining to skip run-level decoding if the third condition is met;
determining to not skip run-level decoding if the third condition is not met;
determining whether a first condition is met if the set is not high resolution;
determining to skip run-level decoding if the first condition is met; and
determining to not skip run-level decoding if the first condition is not met.

31. The method of claim 28, wherein if a mid bit rate category is determined, then the method comprises:
determining whether a fourth condition is met;
determining to skip run-level decoding if the fourth condition is met; and
determining to not skip run-level decoding if the fourth condition is not met.

32. The method of claim 28, wherein determining whether to skip run-level decoding is based on a classification indicator obtained from a bitstream.
